(19) United States
(12) Patent Application Publication
(10) Pub. No.: US 2007/0151697 A1
(43) Pub. Date: Jul. 5, 2007

(54) Preform for foamed sheet product and foamed product manufactured therefrom

(76) Inventors: Adrianus Jacobus Wittebrood, Velserbroek (NL); Hendrik Leendert Schram, Assendelft (NL)

Correspondence Address: STEVENS DAVIS MILLER & MOSHER, LLP, 1615 L STREET, NW, SUITE 850, WASHINGTON, DC, 20036, US

(21) Appl. No.: 10/552,741

(22) PCT Filed: Apr. 16, 2004
(86) PCT No.: PCT/EP04/04250

§ 371 Date: Sep. 8, 2006

(30) Foreign Application Priority Data
Apr. 16, 2003 (EP) 03076130.8

(51) Int. Cl. B22D 27/00; B32B 15/20

(52) U.S. Cl. 164/79; 428/613; 428/654

(57) ABSTRACT

Abstract A preform of a foamable laminate sheet including a core between two metal skin plates, said core comprising a foaming agent and a foamable metal. The foamable metal includes at least one foamable metal sheet. The foaming agent is applied on at least one side of at least one foamable metal sheet.

The invention related to a preform of a foamable laminate sheet comprising a core between two metal skin plates, said core comprising a foaming agent and a foamable metal. The invention further relates to a foamed product manufactured from said preform. The invention also relates to a method for manufacturing said preform. In the present application a novel approach is presented that allows the powder-free production of foamable laminate sheet, also referred to as preform or pre-foamed sheet.

In the most used method to date to produce foamable laminate sheet, aluminium-silicon alloy powders are mixed with titanium hydride. This mixture is then compacted between two metal skin sheets so as to form a preform. This sandwich receives its cellular structure by heating the preform to the melting point of the aluminium-silicon alloy powder mixture. The titanium hydride will decompose and will generate hydrogen gas. This hydrogen will lead to the formation of bubbles in the molten aluminium-silicon alloy mixture. By cooling the foamed structure at the appropriate time a very open structure can be realised between the two metal sheets.

A disadvantage of this known method is that titanium hydride is only added to the mixture in an amount of up to 4 wt. %. Mixing such a small volume of powder homogenously in a large volume of another powder is difficult to do. A further disadvantage is that aluminium powders, or metal powders in general, are very hazardous and can give rise to, when not handled with extreme caution, dust explosions. Still another disadvantage of the known method is that powders are difficult to contain in an area Rolling or compacting powders will require special adjustments of the mill or sample. Also a disadvantage is that the finer the powder the larger the contribution of the always-present oxide. These oxides act as barriers and will inhibit fusion of the powder particles when these are molten, leading to inhomogeneous melting behaviour.

It is an object of this invention to overcome one or more of these disadvantages by providing a new way to produce pre-foamed metal sheets or preforms, such as aluminium or steel sheets.

According to the invention, the object of the invention is reached with a preform of a foamable laminate sheet comprising a core between two metal skin plates, said core comprising a foaming agent and a foamable metal, characterised in that the foamable metal comprises at least one foamable metal sheet and wherein the foaming agent is applied on at least one side of at least one foamable metal sheet. The inventors recognised that it is important in the production of aluminium foam that the foaming agent is evenly distributed. The use of a foamable metal sheet instead of a foamable metal powder which foamable metal sheet is coated with the required amount of foaming agent enables a homogeneous distribution of the foaming agent over the foamable metal sheet. The inventors recognised that it is advantageous to distribute a small amount of powder over a large surface area. The placement of this core of coated foamable metal sheet between two metal layers allows for the production of a metal foam enclosed between two metal skin plates. The resulting laminate sheet couples a high stiffness to a low density.

In an embodiment of the invention the core comprises a plurality of foamable metal layers, stacked on top of each other, which layers are coated on at least one side with at least one foamable metal sheet, preferably wherein each foamable metal layer is coated on at least one side of the foamable metal sheet.

It will be clear that the when the core comprises a plurality of sheets of foamable metal (i.e. at least two), at least one of these sheets is coated on at least one side. It will also be clear that more than one foamable metal sheet may be coated and also that one or more foamable metal sheets may be coated on one or both sides. The amount of foaming agent required, and hence the number of coated foamable metal sheets depends on the foamability of the foamable metal and the type of foam desired after subjecting the preform to a foaming action. If the core comprises two or more foamable metal sheets put on top of one another, then the core may be referred to as a stack. A stacked core results in an improved distribution of the foaming agent over the foamable metal and hence results in a more evenly foamed final product when the preform is subjected to a foaming action.

In an embodiment of the invention the core comprises at least three foamable metal layers, preferably at least four foamable metal layers, more preferably at least five foamable metal layers. More layers of foamable metal sheets coated with a foaming agent in the core results in an improved distribution of the foaming agent over the foamable material and hence results in a better final product when the preform is subjected to a foaming action. It will be clear that the maximum number of layers depends more on the economics of the process and the resultant product, the preform, than on technological limitations.

The foaming agent can be applied by different means. Suitable standard application techniques are roll-coating, dipping, spraying, electrostatic spraying, etc. Application techniques might require some modification of the vehicle that is being used to bring the foaming agent such as TiH₂-particles to the surface of the foamable metal sheet. Preferably contact with water should be avoided at any time. To assure proper adhesion to the foamable metal sheet surface a binder can be used. Preferably, the binder should decompose during heat-up, preferably in such a way that the remaining residue does not interfere with any subsequent foaming action or with any step in the production of the preform.

In an embodiment of the invention, the foamable metal sheet is an aluminium-silicon alloy. This alloy allows production of a preform with excellent foamability.

In an embodiment of the invention the aluminium-silicon alloy sheet is an AA4000-series aluminium alloy, preferably having a silicon content in the range of 4 to 14 wt. %, and more preferably in the range of 8 to 13 wt. %. Suitable aluminium-silicon sheet are selected from the Aluminum Association (“AA”) 4000-series aluminium alloys. AA4000-series alloy sheet is commercially available in a wide thickness range of about 0.05 to 4 mm.

In an embodiment of the invention the aluminium-silicon alloy sheet further comprises an alloying element as wetting agent and/or for modification of the silicon. These aluminium-silicon alloys comprise silicon in combination with alloying elements like zinc, copper, magnesium and others. These elements may lower the melting temperature of the aluminium-silicon alloy or improve wetting behaviour or change the foam structure or any combination thereof. The wetting behaviour can typically be favourably influenced by the addition of small amounts, e.g. up to 1 wt. %, of a wetting agent, such as lead, bismuth, tin, antimony, lithium, and mixtures thereof.

In an embodiment of the invention, the preform has been compressed at elevated temperature prior to a foaming operation. This elevated temperature prior to and during compression, such as hot rolling, should not exceed 400° C. to avoid any decomposition of the foaming agent, and the hot rolling should be carried out at a temperature of the strips and the foaming agent in the range of 220 to 400° C., preferably in the range of 300 to 380° C. Normal hot rolling practice can be applied in order to obtain adherence between the different layers. Rolling reduction of 25% or higher, depending on the number of sheets and thickness of the sheets, will lead to an even adhesion between the different layers. However, it will be understood by the skilled person that a cold rolling operation might also result in an improved adhesion between the various sheets. Furthermore, the rolling will provide even spreading of the foaming agent between the layers, allowing a homogenous foaming operation thereafter.

In an embodiment of the invention the foaming agent is a hydrogenatable metal, wherein the metal is selected from the group consisting of Ti, Fe, Co, Al, Cu, Mg, W, Mn, Cr, Be or an alloy thereof. During heating of these hydrides, the hydrides will decompose and generate the required hydrogen gas. This hydrogen will lead to the formation of bubbles in the molten foamable metal or, in a preferred embodiment, in the aluminium-silicon alloy.

In a preferred embodiment of the invention the foaming agent is provided in the form of titanium hydride (TiH₂) powder in a quantity of from 0.02 to 8 wt. % of the aluminium-silicon alloy sheet, and preferably in a quantity of 0.05 to 2.5 wt. %.

In an embodiment of the invention, at least one metal sheet or foil for lowering the melting point of the aluminium-silicon alloy during any subsequent foaming operation is further interposed between said metal skin plates. With the use of standard AA4000 alloys the choice of said skin plates is limited due to the melting point of the AA4000 alloy. This melting point typically for an AA4000-alloy falls in a range of about 570° C. and 600° C., depending on the silicon content. The metal skin plates should have a melting point above this range and this limits the choice of alloys because most aluminium alloys, in particular the higher alloyed ones, have melting points typically below 570° C. for some relevant phases. To expand the range of usable aluminium skin alloys, an embodiment of the invention is to lower the melting point of the AA4000 sheet alloy. An advantageous way of doing this is to place a thin foil of a suitable metal between the coated AA4000 layers for lowering the melting point of the AA4000 alloy. In a preferable embodiment the foil for lowering the melting point of the aluminium-silicon alloy is made of copper or copper-alloy. The thickness of the foil should be chosen such that the foil and AA4000 sheet have a combined chemistry having a melting point of in a range of 500 to 550° C., and typically around 530° C.

It should be noted that the inventors also found that an improvement in the foaming behaviour can be obtained by using modified silicon alloys. In this context modified means that the sizes of the primary silicon particles in the AA4000 alloy have been decreased. Decreasing the primary silicon particles results in more silicon particles. Melting of an AA4000 alloy is believed to start at the surface of a silicon particle, more silicon particles would result in a more even melting behaviour. Adding small quantities (up to 0.07 wt. %) of alloying elements like sodium or strontium. These elements modify the size of the silicon particles in the AA4000 alloy.

In an embodiment of the invention, the skin plate is selected from the group consisting of aluminium, aluminium alloy, carbon steel, stainless steel and titanium. The layer of foamable metal such as aluminium-silicon alloy coated with a foaming agent or the stack of such layers can be put between two metal skin plates of different alloy types, steel sheet or aluminium sheet, e.g. aluminium alloy selected from the group comprising AA1000, AA2000, AA3000, AA5000, AA6000 and AA7000-series alloys. It depends on the application where the laminate is to be used which metal skin plates are appropriate. In case the metal skin plate is of the same alloy-type as the foamable metal, or has a melting point near or even below that of the foamable metal, cooling of the metal skin plates will be required during the foaming operation to prevent damaging or melting of the metal skin plate or plates. It will be clear that for the two metal skin plates, different metals may be used for each skin plate.

In an embodiment of the invention, one or both of the metal layers is an aluminium brazing sheet, the aluminium brazing sheet comprising an aluminium core alloy clad on one or both sides with a brazing alloy, wherein the brazing alloy preferably is an AA4000-series alloy, and wherein at least one layer of the brazing alloy faces towards the interposed aluminium-silicon alloy sheet. To assure good adhesion of the skin plate during the foaming operation a preferred option would be to use aluminium brazing sheet as skin plate. Aluminium brazing sheet typically comprises an AA3000-series core alloy with a brazeable aluminium alloy layer bonded to one or both sides of the core alloy. Also, core alloys from the group consisting of AA5000, AA6000, and AA2000-series can be selected. Typical aluminium alloys used as a brazeable clad layer are the AA4000-series-alloys, typically having silicon in the range of 4 to 14%, such as for example AA4343 and AA4045. The brazeable aluminium alloys may be bonded to the core alloy in various ways known in the art, for example by means of roll bonding, cladding, semi-continuous or continuous casting processes, or thermal spraying.

In an embodiment and to assure good adhesion, the coated foamable metal sheets can be made corrugated and stacked on top of each other. This corrugation will allow linking between the two sheets during a rolling operation, such as a hot rolling operation, thereby giving a better and uniform distribution of the foaming agent.

The invention is further embodied in a foamed laminate sheet structure comprising two metal skin plates having a foamed aluminium-silicon alloy core structure, which foam structure has been produced with the aid of a preform according to any one of the embodiments as described in this specification.

The invention is also embodied in a method for manufacturing a preform of a foamable laminate sheet as described hereinabove, comprising the steps of
(a) providing at least one foamable metal sheet coated on at least one side with a coating comprising a foaming agent;
(b) assembling said at least one coated foamable metal sheet between two metal layers into an assembly;
(c) applying a controlled load on top of said assembly for improving the bonding between the coating and the foamable metal sheet and to form a preform, wherein preferably the controlled load is applied in a rolling operation.

This embodiment results in a preform of a foamable laminate sheet comprising one coated foamable metal sheet between the metal skin plates or more than one coated foamable metal sheets (i.e. a stack comprising a plurality of sheets) between the metal skin plates with excellent adhesion between the coated foamable metal sheet or sheets themselves (in case of a plurality coated foamable metal sheets) and between the coated foamable metal sheets and the metal skin plates.

In an embodiment of the invention, the foamable metal sheet is an aluminium-silicon alloy. This alloy allows production of a preform with excellent foaming characteristics.

In an embodiment of the invention, the controlled load is applied in a hot rolling operation at a temperature not exceeding 400° C., and preferably the preform is reduced in thickness by at least 25% during the load applying operation.

In an embodiment of the invention the coated foamable metal sheet, such as an aluminium-silicon alloy sheet can be provided corrugated and stacked. The corrugation will allow linking between the two adjacent sheets during the rolling operation giving a better and more uniform distribution of the foaming agent.

The temperature prior to and during hot rolling should not exceed 400° C. to avoid any decomposition of the foaming agent, and the hot rolling being carried out at a temperature of the strips and the foaming agent in the range of 220 to 400° C., preferably in the range of 300 to 380° C. Normal hot rolling practice can be applied in order to obtain adherence between the different layers. Rolling reduction of 25% or higher depending on the number of sheets and thickness of the sheets will lead to an even adhesion between the different layers. However, it will be understood by the skilled person that a cold rolling operation might also result in an improved adhesion between the various sheets. Furthermore, the rolling will cause even spreading of the foaming agent between the layers, allowing an even more homogenous foaming operation thereafter.

A good adherence of the various layers can also be achieved by dedicated rolling practices without high deformation or rolling reduction, for example as described in WO-03/018223, WO-03/018221 and WO-03/022469, incorporated herein by reference. Although the methods disclosed in these prior art documents are for processing monolithic slabs or plates, the disclosed principle can be applied also for manufacturing preforms of foamable laminates in accordance with the invention.

In an embodiment of the invention during assembling of the assembly also at least one metal sheet or foil is interposed between the two metal layers for lowering the melting point of the aluminium-silicon alloy during any subsequent foaming operation. With the use of standard AA4000 alloys the choice of said metal skin plates is limited due to the melting point of the AA4000 alloy. This melting point typically for an AA4000-alloy falls in a range of about 570° C. and 600° C., depending on the amount of silicon used. The metal skin plates should have a melting point above this range and this limits the choice of alloys because most aluminium alloys, in particular the higher alloyed ones, have melting points below 570° C. for some relevant phases. To expand the range of usable aluminium skin alloys, an embodiment of the invention is to lower the melting point of the AA4000 sheet alloy. An advantageous way of doing this is to place a thin foil of a suitable metal between the coated AA4000 layers for lowering the melting point of the AA4000 alloy. In a preferable embodiment the metal sheet or foil for lowering the melting point of the aluminium-silicon alloy is made of copper or copper-alloy. The thickness should be chosen such that the foil and AA4000 sheet have a combined chemistry having a melting point of in a range of 500 to 550° C., and typically around 530° C.

An alternative of the process would be to hot roll the sandwich between two steel skin plates, e.g. low carbon steel or stainless steel. Preferably this combination needs a small hot roll pass to assure good adhesion between the aluminium/silicon and the steel skin plates. However, it is envisaged that also titanium sheet can be used. Also different metal sheet can be used, e.g. one aluminium sheet in combination with a carbon steel sheet.

The invention is also embodied in a method wherein during step (c) of the abovementioned method for manufacturing a preform of a foamable laminate sheet, the resulting preform is provided in the form of a coiled preform. In this embodiment of the invention the foamable preform resulting from the application of a controlled load on top of the assembly comprising two metal skin plates and one or more coated aluminium-silicon sheets is provided coiled on a coil in the form of a coiled preform. This is particularly advantageous if large numbers of products have to be made by e.g. stamping, blanking or cutting.

The invention will now be further described by way of non-limiting examples and with reference to the accompanying drawings in which:

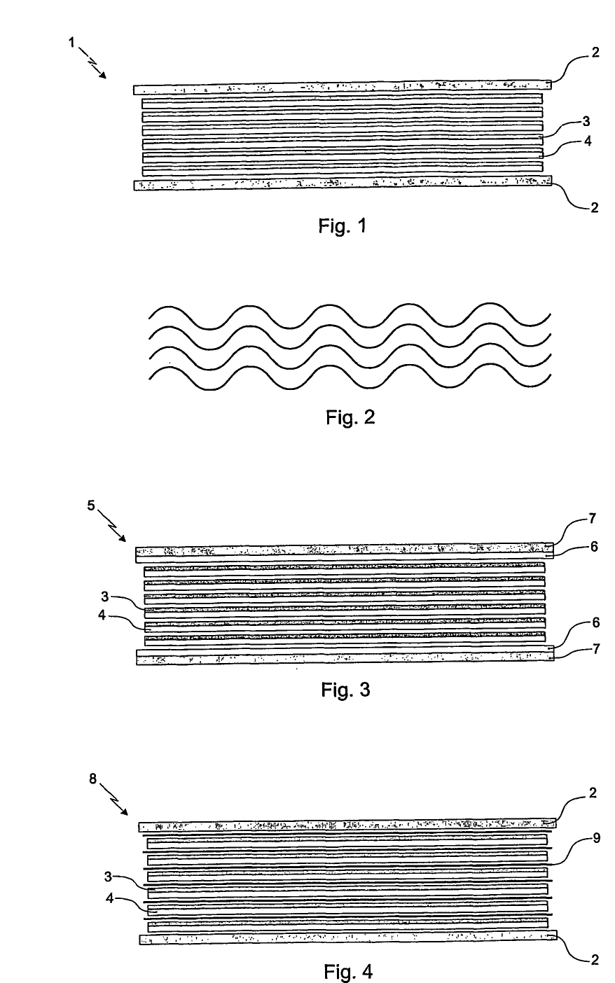

FIG. 1 gives a schematic representation of an embodiment of the concept of the present invention.

FIG. 2 shows schematically an example of a corrugated pattern.

FIG. 3 shows an embodiment of a combination of foaming agent-coated AA4000-alloy sheets with brazing sheet as metal skin plate.

FIG. 4 shows an embodiment of a combination of foaming agent-coated AA4000-alloy sheets with copper foil in between the sheets.

FIG. 1 shows a schematic representation of a foamable laminate sheet 1 according to the invention in the form of a plurality of layers (six layers in this example) of aluminium-silicon alloy sheets 4 coated with the foaming agent 3, between two metal skin plates 2. The metal skin plates may be the same at each side, but they may also be of a different alloy or metal. It will be clear that the melting point of the metal skin plate has to be chosen such that the metal skin plates do not melt during the foaming operation, or that measures have to be taken to prevent the metal skin plates from being damaged or melted. The aluminium-silicon alloys could for example be an AA4000-alloy (e.g. AA4343 or AA4045). In FIG. 1 the coating 3 of the aluminium-silicon alloy sheets 4 is shown to be on the top surface only. It should be noted that it is also possible to have the coating 3 on the bottom surface or on both surfaces of the aluminium-silicon alloy sheet 4. It is not necessary to have a symmetrical distribution of the layers over the thickness, although the more homogeneous the distribution of the layers, the more homogeneous the foamed product will be.

FIG. 2 shows a schematic representation of a stack of four corrugated coated foamable metal sheets. The two metal skin plates are not shown.

FIG. 3 shows a schematic representation of a foamable laminate sheet 5 according to the invention in the form of a plurality of layers (six in this example) of the aluminium-silicon alloy sheets 4 coated with the foaming agent 3, between two metal skin plates of brazing sheet comprising a core alloy 7 and a clad brazing alloy 6 adjacent to the stack of multiple layers of the coated aluminium-silicon alloy. In FIG. 3 the coating 3 of the aluminium-silicon alloy sheets 4 is shown to be on the top surface only. It should be noted that it is also possible to have the coating 3 on the bottom surface or on both surfaces of the aluminium-silicon alloy sheet 4. It is not necessary to have a symmetrical distribution of the layers over the thickness, although the more homogeneous the distribution of the layers, the more homogeneous the foamed product will be. It will also be clear that it is also possible to provide a brazing sheet on one side of the stack and another metal skin plate on the other side, depending on the application and requirements of the foamable laminate sheet.

FIG. 4 shows a schematic representation of a foamable laminate sheet 8 according to the invention in the form of a plurality of layers (six in this example) of the aluminium-silicon alloy sheets 4 coated with the foaming agent 3, between two metal skin plates 2 and wherein foils of copper 9 are inserted between the layers of the coated aluminium-silicon alloy to reduce the melting point thereof.

The preform in accordance with the invention can be used to manufacture a foamed sandwich structure or foamed laminate structure comprising of two metal plates having a foamed aluminium-silicon alloy core structure, which foam structure has been produced with the aid of a preform according to this invention. The thickness of the foamed layers can be chosen in dependence of the application of the foamed laminate, but would typically be in the range of 2 to 25 mm.

After foaming the preform in a known way (for instance by heating the preform) the resultant foamed sheet laminate may find application in components where a low weight has to be combined with a good stiffness for example in components for a vehicle, such as the floor pan, the tailgate or the front panel of an automobile, or in the roof structure of the floor structure of a railway carriage. It may also find application in the form of a component for a marine vessel, such as a component with an increased stiffness for the deck or the superstructure, or a heat-resistant or fire-resistant wall. And it may find application in building constructions, such in the form of a wall for acoustic and/or heat insulation.

It is of course to be understood that the present invention is not in any way limited to the described embodiments and examples described above, but encompasses any and all embodiments within the scope of the description and the following claims.

1. Preform of a foamable laminate sheet comprising a core between two metal skin plates, said core comprising a foaming agent and a foamable metal, wherein the foamable metal comprises at least one foamable metal sheet, and wherein the foaming agent is applied on at least one side of at least one said foamable metal sheet.

2. Preform of a foamable laminate sheet according to claim 1, wherein the core comprises a plurality of foamable metal layers, stacked on top of each other, which layers are coated with foaming agent on at least one side of at least one said foamable metal sheet.

3. Preform of a foamable laminate sheet according to claim 2, wherein the core comprises at least three foamable metal layers.

4. Preform of a foamable laminate sheet according to claim 1. wherein the foamable metal is an aluminium-silicon alloy.

5. Preform of a foamable laminate sheet according to claim 4, wherein the aluminium- silicon alloy sheet is from an AA4000-series aluminium alloy.

6. Preform of a foamable laminate sheet according to claim 4 wherein the aluminium-silicon alloy sheet further comprises an alloying element as wetting agent and/or for modification of the silicon.

7. Preform of a foamable laminate sheet according to claim 1 wherein said preform has been compressed prior to a foaming operation at elevated temperature.

8. Preform of a foamable laminate sheet according to claim 1, wherein the foaming agent is a hydrogenatable metal selected from the group consisting of Ti, Fe, Co, Al, Cu, Mg, W, Mn, Cr, Be or an alloy thereof.

9. Preform of a foamable laminate sheet according to claim 4, wherein the foaming agent is in the form of titanium hydride (TiH2) powder in a quantity of from 0.02 to 8 wt. % of the aluminium-silicon alloy sheet.

10. Preform of a foamable laminate sheet according to claim 4, wherein at least one metal sheet or foil for lowering the melting point of the aluminium- silicon alloy during any subsequent foaming operation is further interposed between said skin plates.

11. Preform of a foamable laminate sheet according to claim 10, wherein the metal sheet or foil for lowering the melting point of the aluminium-silicon alloy is made of copper or copper-alloy.

12. Preform of a foamable laminate sheet according to claim 1, wherein one or both of the skin plates are selected from the group consisting of aluminium, aluminium alloy, carbon steel, stainless steel and titanium.

13. Preform of a foamable laminate sheet according to claim 4, wherein one or both of the skin plates is an aluminium brazing sheet, the aluminium brazing sheet comprising an aluminium core alloy clad on one or both sides with a brazing alloy, wherein at least one layer of the brazing alloy faces the interposed aluminium-silicon alloy sheet.

14. Foamed laminate sheet structure comprising two metal skin plates having a foamed aluminium-silicon alloy core structure, which foam structure has been produced with the aid of a preform according to claim 1.

15. Method for manufacturing a preform of a foamable laminate sheet according to claim 1 comprising the steps of:
(a) providing at least one foamable metal sheet coated on at least one side with a coating comprising a foaming agent;
(b) assembling said at least one coated foamable metal sheet between two metal layers into an assembly;
(c) applying a controlled load on top of said assembly for improving the bonding between the coating and the foamable metal sheet and to form a preform.

16. Method according to claim 15, wherein the foamable metal sheet is an aluminium-silicon alloy.

17. Method according to claim 15, wherein the controlled load is applied in a hot rolling operation at a temperature not exceeding 400° C.

18. Method according to claim 15, wherein during assembling of the assembly also at least one metal sheet or foil is interposed between the two metal skin plates for lowering the melting point of the foamable metal during any subsequent foaming operation.

19. Method according to claim 15, wherein during step (c) the resulting preform is provided in the form of a coiled preform.

20. Preform of a foamable laminate sheet according to claim 1, wherein the core comprises a plurality of foamable metal layers, stacked on top of each other, wherein each foamable metal layer is coated with foaming agent on at least one side of the foamable metal sheet.

21. Preform of a foamable laminate sheet according to claim 2 wherein the core comprises at least four foamable metal layers.

22. Preform of a foamable laminate sheet according to claim 2 wherein the core comprises at least five foamable metal layers.

23. Preform of a foamable laminate sheet according to claim 4, wherein the aluminium- silicon alloy sheet is from an AA4000-series aluminium alloy having a silicon content in the range of 4 to 14 wt. %.

24. Preform of a foamable laminate sheet according to claim 4, wherein the aluminium- silicon alloy sheet is from an AA4000-series aluminium alloy, having a silicon content in the range of 8 to 13 wt. %.

25. Preform of a foamable laminate sheet according to claim 4, wherein the foaming agent is in the form of titanium hydride (TiH2) powder in a quantity of from 0.05 to 2.5 wt. % of the aluminium-silicon alloy sheet.

26. Preform of a foamable laminate sheet according to claim 1, wherein one or both of the metal layers is an aluminium brazing sheet, the aluminium brazing sheet comprising an aluminium core alloy clad on one or both sides with an AA4000-series brazing alloy, and wherein at least one layer of the brazing alloy faces the interposed aluminium-silicon alloy sheet.

27. Method according to claim 15, wherein the controlled load is applied in a rolling operation.

28. Method according to claim 15, wherein the controlled load is applied in a hot rolling operation at a temperature not exceeding 400° C., and the preform is reduced in thickness by at least 25% during the load applying operation.
